(19) United States
(12) Patent Application Publication
(10) Pub. No.: US 2021/0107813 A1
(43) Pub. Date: Apr. 15, 2021

(54) SYSTEMS AND PROCESSES FOR PRODUCING POTASSIUM SULFATE, BARIUM SULFATE, AND/OR CHLORIDE SALTS FROM WASTE STREAMS

(71) Applicant: Marsulex Environmental Technologies Corporation, Lebanon, PA (US)

(72) Inventors: Michael Lyn Mengel, Fredericksburg, PA (US); Michael Tom Hammer, Birdsboro, PA (US); Barry Wayne Stolzman, Nazareth, PA (US); Bronwyn Graeffe, Lititz, PA (US)

(21) Appl. No.: 17/067,175

(22) Filed: Oct. 9, 2020

Related U.S. Application Data
(60) Provisional application No. 62/912,961, filed on Oct. 9, 2019.

(51) Int. Cl. C02F 1/52; C01D 3/08; C01D 5/16

(52) U.S. Cl. CPC C02F 1/5236; C01D 3/08; C02F 2101/101; C02F 2001/5218; C01D 5/16

(57) ABSTRACT

Systems and processes for producing potassium sulfate that include providing an industrial waste material that includes at least sodium sulfate, reacting the sodium sulfate with potassium chloride to produce a byproduct comprising potassium sulfate and a chloride-containing brine, and reacting the chloride-containing brine with barium chloride to produce barium sulfate and sodium chloride.

### CROSS REFERENCE TO RELATED APPLICATIONS

This application claims the benefit of U.S. Provisional Application No. 62/912,961 file Oct. 9, 2019, the contents of which are incorporated herein by reference.

### BACKGROUND OF THE INVENTION

The present invention generally relates to production of useful compounds from waste streams. The invention particularly relates to systems and processes for converting industrial waste streams into agricultural grade potassium sulfate fertilizer, and additionally or alternatively the production of barium sulfate and chloride salts from such waste streams.

Potassium (K)-containing fertilizers are commonly added to soils that are lacking an adequate supply of this essential nutrient to improve the yield and quality of agricultural plants growing in such soils. Most K-containing fertilizers come from natural salt deposits located throughout the world. The word “potash” is a general term that most frequently refers to potassium chloride (KCl), but it can also apply to other K-containing fertilizers, such as potassium sulfate (K₂SO₄, commonly referred to as sulfate of potash, or SOP). Potash fertilizers may also encompass potassium carbonate (K₂CO₃) and/or potassium nitrate (KNO₃). Though potash fertilizers do not contain potassium oxide (K₂O), their potassium contents are often reported as a K₂O equivalent as a basis for comparing fertilizers that contain different forms of potash.

Potassium is a relatively abundant element in the Earth's crust, and production of potash fertilizer occurs in every inhabited continent. However, K₂SO₄ is rarely found in a pure form in nature. Instead it is naturally mixed with salts containing magnesium (Mg), sodium (Na), and chloride (CI). Various processes have been used to produce K₂SO₄. For example, natural K-containing minerals (e.g., kainite, schoenite, leonite, langbeinite, glaserite, polyhalite, etc.) are mined and carefully rinsed with water and salt solutions to remove byproducts and produce K₂SO₄. Other industrial processes that have been proposed for producing K₂SO₄ from sources other than mined minerals are often commercially impractical due to the high cost of input materials.

In traditional lead battery recycling processes, water and a lead paste recovered from expired lead batteries are delivered to one or more reaction tanks, where sodium carbonate (soda ash; Na₂CO₃) is used as a reagent to convert the lead paste (lead sulfate; PbSO₄) to lead carbonate (PbCO₃) and sodium sulfate (Na₂SO₄). Liquid waste streams containing sodium sulfate are typically disposed of, which can be not only a challenging practice, but also financially costly. In addition, governments are increasingly focused on discharge regulations and have mandated effluent guidelines. As a result of stricter water rules, including minimizing total dissolved solids (TDS) from effluent streams and achieving zero liquid discharge (ZLD), industries have adopted post-treatment processes. As an example, liquid sodium sulfate waste streams may be processed to produce a solid waste stream that contains crystallized sodium sulfate, which provides little to no economic recovery and is costly to dispose of in a landfill.

In view of the above, it can be appreciated that it would be desirable if systems and processes were available for producing potassium sulfate from sources other than mined minerals, as well as systems and processes capable of converting industrial waste streams into economically valuable products, including but not limited to potassium sulfate.

### BRIEF DESCRIPTION OF THE INVENTION

The present invention provides systems and processes for producing useful compounds from waste streams.

According to one aspect of the invention, a process is provided for producing potassium sulfate that includes providing an industrial waste material that includes at least sodium sulfate, reacting the sodium sulfate with potassium chloride to produce a byproduct comprising potassium sulfate and a chloride-containing brine, and reacting the chloride-containing brine with barium chloride to produce barium sulfate and sodium chloride.

According to another aspect of the invention, a system is provided for producing potassium sulfate that includes a source of industrial waste material that includes at least sodium sulfate, the capability for separating the sodium sulfate from the industrial waste material, a first reaction tank in which the sodium sulfate is reacted with potassium chloride to produce a byproduct comprising potassium sulfate and a chloride-containing brine, and a second reaction tank in which the chloride-containing brine is reacted with barium chloride to produce barium sulfate and sodium chloride.

Technical effects of processes and systems having features as described above preferably include the capability of efficiently producing potassium sulfate from waste streams that contain sodium sulfate, potentially at a reduced cost relative to conventional processes that produce potassium sulfates from mined minerals. In certain embodiments, the processes and systems are capable of converting industrial waste streams into agricultural grade potassium sulfate fertilizer, and additionally or alternatively produce barium sulfate and chloride salts from such waste streams.

Other aspects and advantages of this invention will be appreciated from the following detailed description.

### BRIEF DESCRIPTION OF THE DRAWINGS

FIG. 1 schematically represents a system for producing solid sodium sulfate from a liquid waste stream that contains sodium sulfate in accordance with a nonlimiting embodiment of this invention.

FIG. 2 schematically represents a system capable of use in combination with the system of FIG. 1 and configured for producing solid potassium sulfate and sodium chloride in accordance with a nonlimiting embodiment of this invention.

FIG. 3 schematically represents a system capable of use in combination with the system of FIG. 2 and configured for producing a slurry that contains barium sulfate crystals and a purer sodium chloride-containing solution in accordance with a nonlimiting embodiment of this invention.

FIG. 4 schematically represents a system capable of use in combination with the system of FIG. 3 and configured for producing a solid sodium chloride product from a sodium chloride-containing solution in accordance with a nonlimiting embodiment of this invention.

### DETAILED DESCRIPTION OF THE INVENTION

The present disclosure relates to systems and processes that may be used to produce potassium sulfate (K₂SO₄), including but not limited to agricultural grade potassium sulfate, from waste streams that contain (or may be reacted to contain) sodium sulfate (Na₂SO₄). Broadly, the process reacts sodium sulfate with potassium chloride (KCl) to produce potassium sulfate as a high-value usable byproduct, and can further perform additional reactions to produce high quality barium sulfate crystals and liquid or solid chloride salts. Though the process can be applied to sodium sulfate waste streams generated by various industries, including the primary mining metals processing and recovery industry and the refinery sector, waste streams of particular interest are believed to be those generated by recycling of alkaline batteries, including the recovery of their lead paste (predominantly PbSO₄) and spent electrolyte (sulfuric acid; H₂SO₄). As such, one aspect is to provide processes and systems that offer the ability to eliminate or at least reduce certain industrial wastes while simultaneously providing an economic benefit and a more environmentally friendly alternative to the disposal of sodium sulfate waste materials.

In addition to sodium sulfate waste streams, feed streams for the process include potassium chloride and, according to a preferred aspect, barium chloride (BaCl₂). The process preferably reacts crystallized (solid) sodium sulfate and potassium chloride to produce salable dried potassium sulphate crystals and a brine solution that contains sodium chloride (NaCl), the latter of which can then be reacted with barium chloride to produce barium sulfate (BaSO₄) and chloride salts (including sodium chloride) that are of higher purity so as to be suitable for use in various applications in a wide variety of industries.

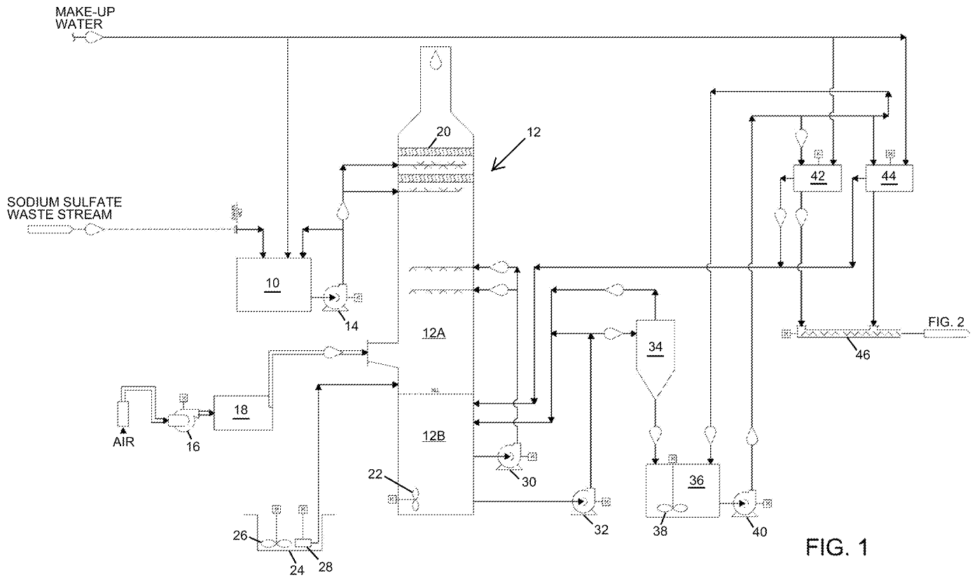

Nonlimiting embodiments of systems that, in combination, are capable of producing potassium sulfate barium sulfate, and chloride salts from waste streams are represented in FIGS. 1 through 4. Although the invention will be described hereinafter in reference to the systems and particular equipment schematically identified in the drawings, it should be noted that the teachings of the invention are not limited to these particular equipment, and the invention does not require all of the features/functions or the interfunctionality represented for the systems and equipment in the drawings.

The systems represented in FIGS. 1 through 4 may individually be viewed as subsystems of a complete system adapted to carry out the following general reactions:

Na₂SO₄+K₂SO₄→(K,Na)₃Na(SO₄)₂ Eq. 1

(K,Na)₃Na(SO₄)₂+KCl→K₂so₄+NaCl Eq. 2

(K,Na)₃Na(SO₄)₂+BaCl₂→NaCl+KCl+BaSO₄ Eq. 3

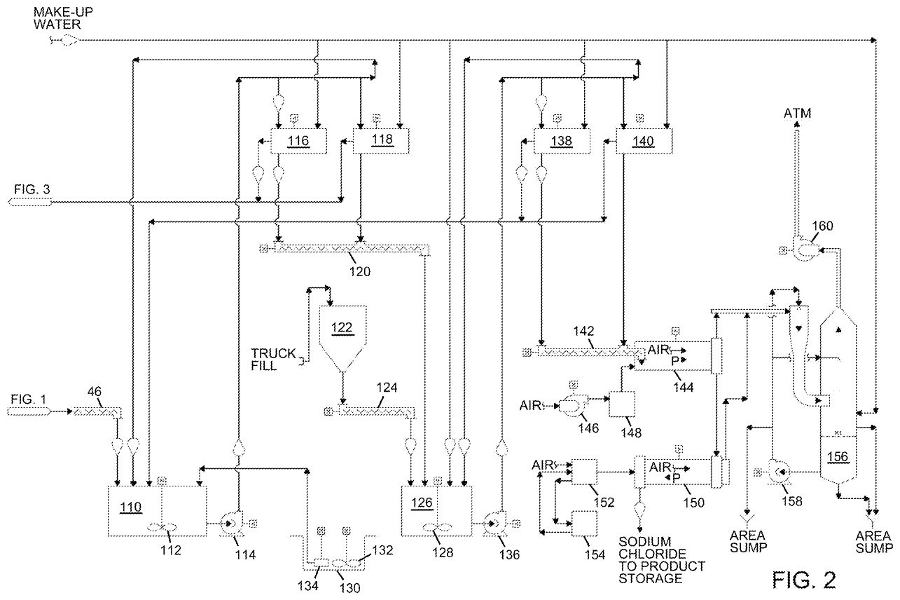

As a nonlimiting example, sodium sulfate (Na₂SO₄) used by the process may be a byproduct of reacting sodium carbonate (soda ash; Na₂CO₃) with a lead paste (lead sulfate; PbSO₄) recovered from expired lead batteries, which conventionally produces lead carbonate (PbCO₃) as the intended product. The ingredients of reaction Eq. 1 are crystallized (solid) sodium sulfate, potassium sulfate, and water, which are combined to form glaserite (aphthitalite; (K,Na)₃Na(SO₄)₂), as represented in FIG. 2.

The system depicted in FIG. 1 is represented as producing solid sodium sulfate from a liquid waste stream that contains sodium sulfate. In this system, a sodium sulfate waste stream is deposited into an absorber feed tank 10. One or more pumps 14 transfer the waste stream to a contact zone 12A located within an evaporative absorber tower 12, for example, through nozzles or other dispensing equipment capable of introducing the waste stream as a spray or droplets within the contact zone 12A. Warm air is directed into the contact zone 12A at a location below the waste inlet, for example, with an inlet fan 16 and an air heater 18. The warm air, flowing countercurrently to the waste stream within the contact zone 12A, removes moisture from the incoming waste stream, and the humidified air containing the removed moisture passes through one or more mist eliminators 20 before being vented to atmosphere through an outlet of the tower 12 located above the mist eliminators 20. The resulting relatively warmer and drier waste material collects within a tank 12B located within the tower 12 below the contact zone 12A, where it is circulated with an agitator 22. The tower 12 may be coupled to an area sump 24 that includes an agitator 26 and a sump pump 28.

A portion of the waste material collected within the tank 12B of the tower 12 may be recirculated to the contact zone 12A with recycle pumps 30. The waste material in the tank 12B is removed from the tower 12 with bleed pumps 32 and transferred to a primary hydrocyclone cluster 34. Excess material may be returned to the tower 12 while separated materials are deposited into a feed tank 36 that includes an agitator 38. The material in the feed tank 36 is then transferred via feed pumps 40 to centrifuges 42 and 44 which separate solid sodium sulfate from liquids. The liquids can be returned to the tower 12 while the solid sodium sulfate enters a weighfeeder 46.

The system depicted in FIG. 2 is represented as reacting the solid sodium sulfate produced in FIG. 1 with potassium sulfate to form glaserite (Eq. 1), and then reacting the glaserite with potassium chloride to produce solid potassium sulfate and sodium chloride (Eq. 2). In FIG. 2, the solid sodium sulfate exits the weighfeeder 46 (FIG. 1) to enter a glaserite formation tank 110 comprising an agitator 112 where the sodium sulfate and potassium sulfate combine to form glaserite (Eq. 1). The resulting glaserite slurry is directed from the formation tank 110 via feed pumps 114 to centrifuges 116 and 118 that separate glaserite from a glaserite-containing centrate. The glaserite is transferred via a weigh feeder 120 to a reaction tank 126 that includes an agitator 128. Potassium chloride is provided from a storage silo 122 to the reaction tank 126 via a weighfeeder 124. In the reaction tank 126, the glaserite reacts with the potassium chloride to form potassium sulfate and sodium chloride (Eq. 2).

The resulting slurry is transferred with feed pumps 136 to centrifuges 138 and 140 to remove a centrate that contains chlorides and potassium sulfate to yield a potassium sulfate liquor. The centrate is recycled to the glaserite formation tank 110 where the potassium sulfate reacts with the incoming solid sodium sulfate to produce more glaserite (Eq. 2). The potassium sulfate liquor may be removed and, for example, sold as a liquid or, as shown in FIG. 2, further refined into solid potassium sulfate utilizing a crystallization process. As represented, the potassium sulfate liquor exits the centrifuges 138 and 140 onto a discharge conveyor 142 and is deposited into a raw product dryer 144. Warm air is directed into the dryer 144, for example, with a fan 146 and burner 144, to dry the potassium sulfate liquor. The dried product is transferred to a product cooling drum 150 which has cooling air that flows counter to the travel direction of the dried product. This may be accomplished with a dehumidification system 152 and condenser system 154. Solid potassium sulphate may be collected from the cooling drum 150 and stored. Dust accumulated in the raw product dryer 144 may be directed into a dust scrubber 156. Material within the scrubber 156 may be recycled into upper portions of the scrubber 156 with a recycle pump 158. Collected dust is directed to area sumps whereas gases within the process may be released from an upper end of the scrubber 156 through a dust collection fan 160 and directed through an outlet into the atmosphere (ATM).

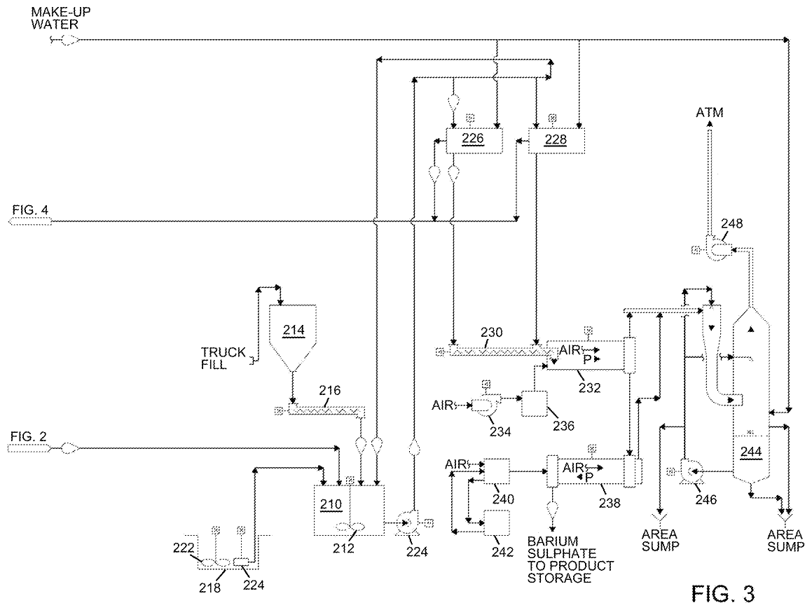

The system depicted in FIG. 3 is represented as reacting the glaserite-containing centrate of FIG. 2 with barium chloride to produce a slurry that contains barium sulfate crystals and a purer sodium chloride-containing solution (Eq. 3). Specifically, the glaserite-containing centrate collected with the centrifuges 116 and 118 is directed to a barium sulphate reaction tank 210 that includes an agitator 212 and is coupled with an area sump 218 having a sump pump 220 and an agitator 222. Barium chloride is provided from a storage silo 214 to the reaction tank 210 via a weighfeeder 216. In the reaction tank 210, the glaserite reacts with the barium chloride to form barium sulfate, sodium chloride, and potassium chloride (Eq. 3). The barium sulfate can then be removed from the reaction tank 210 with pumps 224 and separated with centrifuges 226 and 228 from a centrate that contains sodium chloride and potassium chloride. The barium sulfate is transferred with a discharge conveyor 230 to a raw product dryer 232 and dried to yield a solid barium sulfate product. Warm air is directed into the raw product dryer 232, for example, with a burner fan 234 and a dryer burner 236. The dried product is deposited in a product cooling drum 238 which has cool air flowing counter to the travel direction of the dried product. This may be accomplished with a dehumidification system 240 and condenser system 242. Solid barium sulphate may be collected from the cooling drum 238 and stored. Dust accumulated in the raw product dryer 232 may be directed into a dust scrubber 244. Material above a base of the scrubber 244 may be recycled into upper portions of the scrubber 244 with a recycle pump 246. Collected dust is directed to area sumps whereas gases within the process may be released at a top of the scrubber 244 through a dust collection fan 248 and directed through an outlet into the atmosphere (ATM).

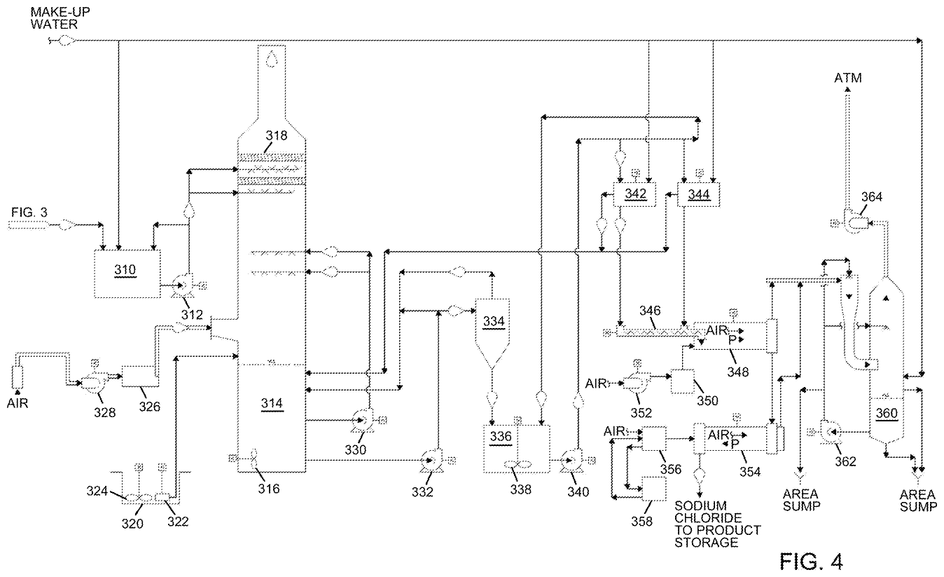

The centrate containing sodium chloride and potassium chloride (generally a sodium/potassium chloride solution) separated with the centrifuges 226 and 228 may be sold as is or, as shown in FIG. 4, undergo further processing to produce a solid sodium chloride product. In the system represented in FIG. 4, the centrate is deposited into an absorber feed tank 310. Pumps 312 transfer the centrate into an upper end of an evaporative absorber tower 314. Warm air is directed into the tower 314 at a location below the solution inlet, for example, with an inlet fan 328 and an air heater 326. The warm air drys the incoming centrate and moisture escapes through an outlet at a top of the tower 314. The material located at a base of the tower 314 is circulated with an agitator 316. The tower 314 is coupled to an area sump 320 that includes an agitator 324 and a sump pump 322.

The material located above the base of the tower 314 may be re-circulated into the tower 314 with recycle pumps 330. The material at the base of the tower 314 is removed from the tower 314 with bleed pumps 332 and transferred to a primary hydrocyclone cluster 334. Excess material may be returned to the tower 314 while separated materials are deposited into a feed tank 336 that includes an agitator 338. The material in the feed tank 336 is then transferred via feed pumps 340 to centrifuges 342 and 344 which separate solid sodium chloride from the remaining liquid centrate, which are represented as being returned to the tower 314.

The sodium chloride is transferred with a discharge conveyor 346 to a raw product dryer 346 and dried to yield a solid sodium chloride product. Warm air is directed into the raw product dryer 346, for example, with a burner fan 352 and a dryer burner 350. The dried product is deposited in a product cooling drum 354 which has cool air flowing counter to the travel direction of the dried product. This may be accomplished with a dehumidification system 356 and condenser system 358. Solid sodium chloride product may be collected from the cooling drum 354 and stored. Dust accumulated in the raw product dryer 348 may be directed into a dust scrubber 360. Material above a base of the scrubber 360 may be recycled into upper portions of the scrubber 360 with a recycle pump 362. Collected dust is directed to area sumps whereas gases within the process may be released at a top of the scrubber 360 through a dust collection fan 362 and directed through an outlet into the atmosphere (ATM).

Notable benefits of the multiple processing steps described above include the ability to achieve potassium sulfate recovery levels exceeding 50% and preferably exceeding 80% of the starting sodium sulphate weight, and the production of barium sulfate and chloride salts from the resulting sodium chloride waste stream. Importantly, the barium sulfate is of high quality and suitable for use in a wide variety of industries, and the sodium chloride product is purer than what can otherwise be achieved by the reaction of Eq. 2 such that the resulting chloride product is more suitable for use in applications.

While the invention has been described in terms of particular embodiments, it is apparent that other forms could be adopted by one skilled in the art. For example, the process could be performed with systems utilizing various components, and various other industrial waste materials could serve as the feedstock. In addition, the process systems represented in FIGS. 1 through 4 could differ from those shown. Therefore, the scope of the invention is to be limited only by the following claims.

1. A process for producing potassium sulfate, the process comprising:
providing an industrial waste material that includes at least sodium sulfate;
reacting the sodium sulfate with potassium chloride to produce a byproduct comprising potassium sulfate and a chloride-containing brine; and
reacting the chloride-containing brine with barium chloride to produce barium sulfate and sodium chloride.

2. The process of claim 1, further comprising processing the potassium sulfate to produce solid potassium sulfate.

3. The process of claim 2, wherein the processing comprises a crystallization process.

4. The process of claim 1, further comprising producing the sodium sulfate from a lead paste obtained from lead batteries.

5. The process of claim 1, wherein the sodium sulfate is produced by reacting lead sulphate and sodium carbonate to produce lead carbonate and the sodium sulfate.

6. The process of claim 1, wherein the chloride-containing brine contains glaserite.

7. The process of claim 1, wherein the sodium chloride produced by reacting the chloride-containing brine is a higher quality than sodium chloride in the chloride-containing brine.

8. The process of claim 1, wherein the process achieves a potassium sulfate recovery level exceeding 50% of the starting sodium sulphate weight.

9. The process of claim 1, wherein the process achieves a potassium sulfate recovery level exceeding 80% of the starting sodium sulphate weight.

10. The process of claim 1, further comprising processing the sodium chloride to produce solid sodium chloride.

11. A system for producing potassium sulfate, the system comprising:
a source of industrial waste material that includes at least sodium sulfate;
means for separating the sodium sulfate from the industrial waste material;
a first reaction tank in which the sodium sulfate is reacted with potassium chloride to produce a byproduct comprising potassium sulfate and a chloride-containing brine; and
a second reaction tank in which the chloride-containing brine is reacted with barium chloride to produce barium sulfate and sodium chloride.

12. The system of claim 11, further comprising means for separating the potassium sulfate from the chloride-containing brine and processing the potassium sulfate to produce solid potassium sulfate.

13. The system of claim 12, wherein the processing comprises a crystallization process.

14. The system of claim 1, further comprising means for producing the sodium sulfate from a lead paste obtained from lead batteries.

15. The system of claim 1, further comprising means for producing the sodium sulfate by reacting lead sulphate and sodium carbonate to produce lead carbonate and the sodium sulfate.

16. The system of claim 1, wherein the chloride-containing brine contains glaserite.

17. The system of claim 1, wherein the sodium chloride produced by reacting the chloride-containing brine in the second reaction tank is a higher quality than sodium chloride in the chloride-containing brine.

18. The system of claim 1, wherein the system is configured to produce a potassium sulfate recovery level exceeding 50% of the starting sodium sulphate weight.

19. The system claim 1, wherein the system is configured to produce a potassium sulfate recovery level exceeding 80% of the starting sodium sulphate weight.

20. The system of claim 1, further comprising means for processing the sodium chloride to produce solid sodium chloride.
